(19) United States
(12) Patent Application Publication
(10) Pub. No.: US 2023/0106741 A1
(43) Pub. Date: Apr. 6, 2023

(54) AUTOMATIC TRAY NOTCH MACHINE

(71) Applicant: Skyworks Solutions, Inc., Irvine, CA (US)

(72) Inventors: Daniel Orozco Mariscal, Mexicali (MX); Raul Jacobo, Mexicali (MX); Edgar Antonio Martinez, Mexicali (MX)

(21) Appl. No.: 17/937,183

(22) Filed: Sep. 30, 2022

Related U.S. Application Data
(60) Provisional application No. 63/252,025, filed on Oct. 4, 2021.

(51) Int. Cl. B23B 35/00

(52) U.S. Cl. CPC B23B 35/00

(57) ABSTRACT

An automatic drilling equipment for drilling notches in a plurality of trays includes a drilling tool and a tray base to hold and move a plurality of trays on the tray base with respect to the drilling tool. The drilling tool is operable to drill the plurality of trays to simultaneously open a notch at the same position in each tray of the plurality of trays.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure relates to an automatic drilling equipment and to an automatic drilling method for trays.

### Description of the Related Art

In the semiconducting field, packaging trays are normally used for storing and transporting chips during the chips fabrication process. As one of the most important steps, the manufactured chips are tested by an electrical equipment (e.g. electrical test handler) to verify the quality of the chips. The chips, which may be detected and rejected by the electrical equipment due to faults or contaminations, are collected in a set of specific trays called “failure trays”. These failure chip trays are then required to be differentiated from the other trays containing chips that passed the electrical test.

A specifically designated position for placing these trays of failures may be prepared with an installed metal element, such as a pin. This specific position allows only a tray marked with a matched notch to load at the position. At the same time, this also prevents a tray passing the electrical test, which does not have a matched notch, to be placed in this location, and thus avoids the possible mixture of good-quality products with defective products.

Therefore, it is required to perform and drill a notch on the packaging failure trays. Conventionally, the notch must be performed manually and sometimes may lead to problems. For example, an operator may sometimes drill out of the marked place. A previous solution for drilling the failure trays includes a drilling machine. However, the drilling machine only allowed the drilling process to be performed for one tray at a time.

### SUMMARY

In accordance with one aspect of the disclosure, an automatic drilling equipment is desired which can be loaded with more than one failure tray. The more than one failure trays are drilled with a notch at the same time and at the same position which would be more time efficient and accurate.

According to one aspect of the disclosure, an automatic drilling equipment for drilling notches in a plurality of trays is provided, the equipment comprising: a drilling tool; a tray base configured to hold and move a plurality of trays on the tray base with respect to the drilling tool, said drilling tool is configured to drill the plurality of trays to open a notch at the same position in each tray of the plurality of trays at the same time.

In one example, the plurality of trays are packaging trays for failure chips.

In one example, the plurality of trays consists of four or more trays in a stack.

In one example, the tray base further comprises at least one tray clamp for securing the plurality of trays on the tray base.

In one example, the drilling tool of the automatic drilling equipment comprises a motor for driving a drilling process.

In one example, the automatic drilling equipment further comprises a vacuum cleaning tool for cleaning generated debris.

In one example, the plurality of tray clamps comprises a plurality of sensors configured to detect the presence of a loaded plurality of trays on the tray base.

In one example, the tray base further comprises a bearing tool for controlling the movement of the tray base.

In one example, the automatic drilling equipment further comprises a pneumatic system for operating a drilling process.

In one example, the automatic drilling equipment further comprises a maintenance screen.

In one example, the automatic drilling equipment further comprises a status traffic light.

In one example, the automatic drilling equipment further comprises an emergency stop button.

In one example, the automatic drilling equipment further comprises access doors for shielding the drilling equipment.

In one example, the automatic drilling equipment further comprises a reset button, a start button and a stop button.

In one example, the automatic drilling equipment has a cabinet divided into two discrete compartments, including an upper compartment containing the drilling tool and a lower compartment containing the vacuum cleaning tool.

According to another aspect of the present disclosure, an automatic drilling method for trays is provided, comprising loading a plurality of trays on a tray base; moving the plurality of trays with respect to a drilling tool by a motor connected to the tray base; drilling the plurality of trays by the drilling tool; and opening a notch at the same position for each tray of the plurality of trays by the drilling tool at the same time.

In one example, the plurality of trays are packaging trays for failure chips.

In one example, the plurality of trays consists of four or more trays in a stack.

In one example, the automatic drilling method for trays further comprises securing the plurality of trays on the tray base by a plurality of tray clamps.

In one example, the automatic drilling method for trays further comprise driving the drilling tool by a motor.

In one example, the automatic drilling method for trays further comprises cleaning generated debris by a vacuum cleaning tool.

In one example, the automatic drilling method for trays further comprises detecting the loaded plurality of trays on the tray base by a plurality of sensors.

In one example, the automatic drilling method for trays further comprises controlling the movement of the tray base by a bearing.

In one example, the drilling process is operated by a pneumatic system.

Still other aspects, embodiments, and advantages of these aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is an isometric view of a tray notch machine;

FIG. 2 is a first side elevational view of the tray notch machine shown in FIG. 1;

FIG. 3 is a front elevational view of the tray notch machine shown in FIG. 1;

FIG. 4 is a second side elevational view of the tray notch machine shown in FIG. 1, the second side being opposite the first side in FIG. 2;

FIG. 5 is an exploded isometric view of the tray notch machine of FIG. 1 showing the assembly of the upper compartment;

FIG. 6 is an isometric views of the tray notch machine of FIG. 1 showing the lower compartment;

FIG. 7 is isometric views of the tray notch machine of FIG. 1 showing the interior of the two main parts of the lower compartment shown in FIG. 6;

FIG. 8 is an exploded isometric view of the tray notch machine shown in FIG. 7 showing the assembly of the mechanism assembly;

FIG. 9 is a first isometric view of the notch mechanism shown in FIG. 7;

FIG. 10 is a top view of the notch mechanism shown in FIG. 7;

FIG. 11 is a second isometric view of the notch mechanism shown in FIG. 7;

FIG. 12 is a schematic diagram for electrical assembly of the tray notch machine show in FIG. 1;

FIG. 13 is a schematic pneumatic diagram for the tray notch machine show in FIG. 1.

### DETAILED DESCRIPTION

Aspects and embodiments described herein are directed to an automatic drilling equipment for drilling notches in a plurality of trays, the equipment including a drilling tool and a tray base that can hold and move a plurality of trays on the tray base with respect to the drilling tool. The drilling tool can drill the plurality of trays to open a notch at the same position in each tray of the plurality of trays at the same time (e.g., simultaneously).

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

This present disclosure relates to an automatic drilling equipment which physically modifies the failure trays used for storing and transporting chips that have been rejected due to faults or contaminations detected by an electrical test. The disclosed drilling equipment allows a maximum of four trays in a stack to be drilled at one time in a single operation. The trays are drilled with notches which are located in the same position so that they trays can engage the metal pin of the designated place for failure trays. In this regard, the notch can be understood to include holes, grooves, cut-outs, perforations, or other surface features with a predetermined desired profile for serving a designated function.

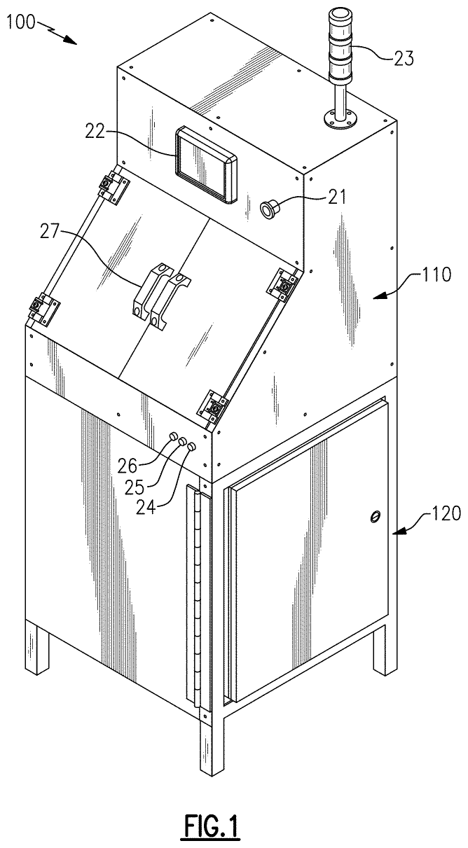

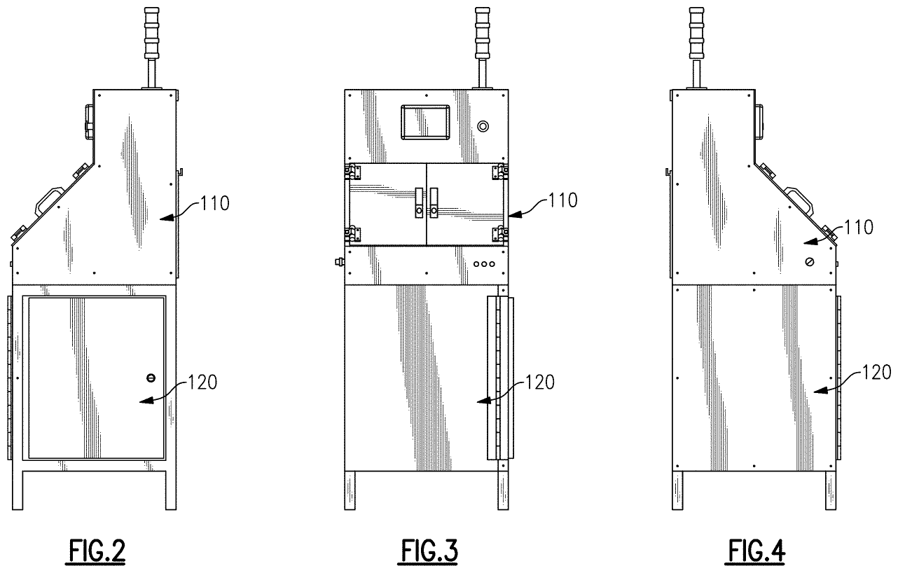

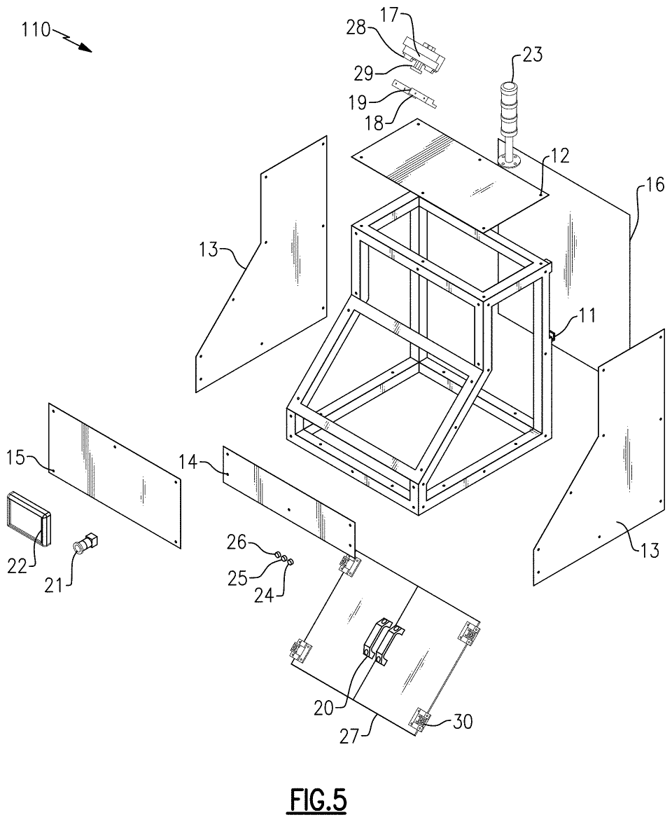

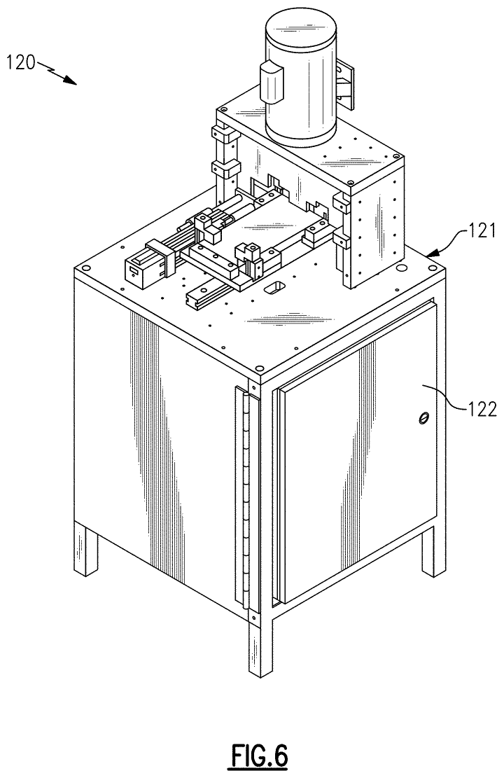

FIG. 1 shows an isometric view of the outside of a tray notch machine 100. Two side views of the tray notch machine 100 shown in FIG. 1 are demonstrated in FIGS. 2 and 4, and a front elevational view of the tray notch machine 100 shown in FIG. 1 is demonstrated in FIG. 3. As shown in FIG. 1, the tray notch machine 100 includes an upper compartment 110 and a lower compartment 120. FIGS. 2 to 4 also demonstrate the three different views of the upper compartment 110 and lower compartment 120. From the outside views shown in FIGS. 1 to 4, some main components can be seen which have various different functions according to aspect of the disclosure. As shown in FIG. 1, a maintenance screen 22 including a monitor is mounted on the upper front part 110 of the tray notch machine 100, which is the interface for registering preventive maintenance. At the right hand side of the maintenance screen 22, an emergency stop 21 is mounted which serves to stop the tray notch machine 100 in an unexpected or emergency situation. In some embodiments, an automatic cycle counter (not shown in FIG. 1) may also be mounted on the upper front part 110 of the tray notch machine 100. The automatic cycle counter shows the number of cycles that have been grooved. In some embodiments, one counted cycle may equal to four single-sided slotted trays which are loaded on the tray notch machine 100. An access door 27 is positioned in front of the tray notch machine 100 where a plurality of trays to be grooved are introduced through this space. The tray notch machine 100 may also include three functional buttons which are located below the access door 27. The three buttons include a stop button 24 (e.g., a red button) which serves to stop the grooving process, a start button 25 (e.g., a green button) which is used to start the grooving process, and a reset button 26 (e.g., black button) which is used to restart the grooving cycle or restart after an alarm.

In some embodiments, a status traffic light 23 may be mounted on the top edge of the tray notch machine 100 as shown in FIG. 1. The status traffic light 23 shows an indication of the conditions of the tray notch machine 100 to the operator. The color of the traffic light 23 and the status of the color (e.g. on, off or flashing) may be identified for different conditions of the tray notch machine 100. In some examples, the identification is as follow:

| State | Red | Orange | Green |
|---|---|---|---|
| Initializing | ON | OFF | OFF |
| Machine ready | OFF | OFF | ON |
| Processing | OFF | ON | OFF |
| Front doors open | OFF | OFF | Flashing |
| Wrong number of | Flashing | ON | OFF |
| trays | | | |
| Back door open | Flashing | OFF | OFF |
| Spindle guard open | Flashing | OFF | Flashing |
| Lack of pneumatic | ON | OFF | ON |
| pressure | | | |

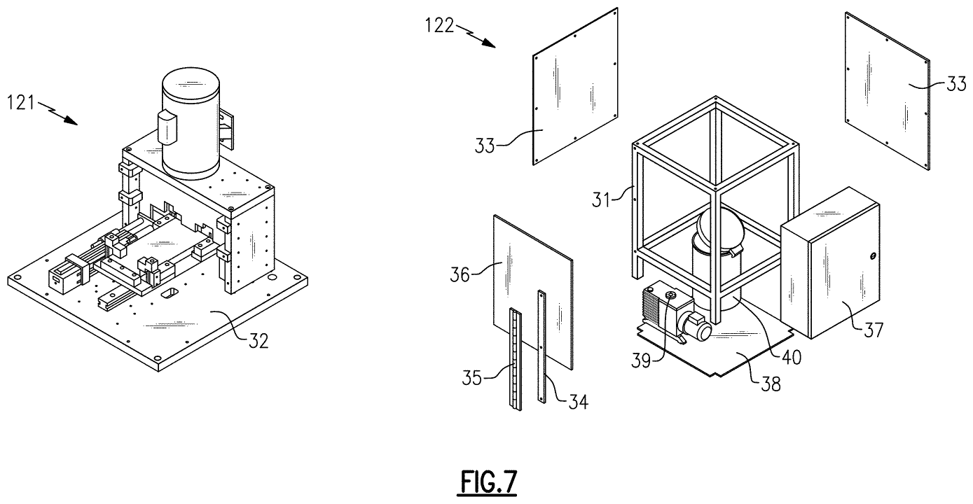

The assembly of the tray notch machine 100 is shown and described in FIGS. 5 to 8. FIG. 5 shows a detailed assembly of the upper compartment 110 shown in FIG. 1. The upper compartment 110 is a frame-based structure and includes a frame 11 enclosed by a set of covers at each side. The set of covers includes a top cover 12, two side covers 13, a front cover 14, a motor cover 15, and a back cover 16. As shown in FIG. 5, as well as in FIG. 1, a tower light 23 is assembled on (or attached to) the top cover 12. Three small buttons are assembled on (or attached to) the front cover 14, including a stop button 24, a start button 25, and a reset button 26. An emergency stop button 21 and a maintenance screen 22 are assembled on (or attached to) the motor cover 15. An open area in a rectangular shape of the frame 11 may be left after being enclosed by the set of covers 12 to 16. A door 27 as shown in FIG. 5 is embedded in this open area. The door 27 is supported by a safety door cylinder support 17 and secured by a pair of latching blocks, including right door latching block 18 and left door latching block 19. The door 27 also includes a pair of door handles 20 and four hinges 30 at each side of the door 27.

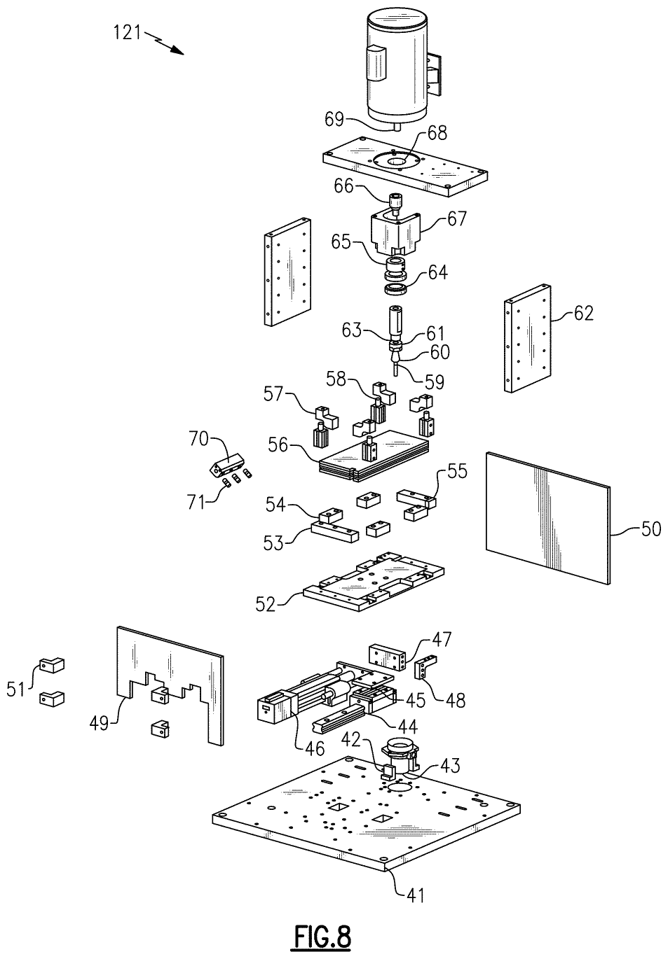

FIG. 6 shows a detailed view of the lower compartment 120 shown in FIG. 1. The lower compartment 120 is further divided into two parts including a mechanism assembly 121 at the top and a frame assembly 122 at the bottom. As it can be seen in FIG. 1, the mechanism assembly 121 is covered by the entire upper compartment 110. FIG. 7 demonstrates a view of the mechanism assembly 121 and the bottom frame assembly 122 of the lower compartment 120. The bottom frame assembly 122 includes a central frame 31 in a rectangular shape enclosed by a set of covers or panels at each side. The set of covers includes two side covers 33 and a bottom cover 38. The top side of the central frame 31 is covered by a mechanism base 32 of the mechanism assembly 121 which joins the mechanism assembly 121 and the frame assembly 122 together. One side of the rectangular-shaped central frame 31 is covered by a service door 36 as shown in FIG. 7. The service door 36 includes a hinge spacer 34 and a hinge 35 as shown in FIG. 7. A control cabinet 37 is embedded into another side of the rectangular-shaped central frame 31. A vacuum generator 39 and a waster container 40 are assembled on the bottom cover 38 which are positioned inside the central frame 31.

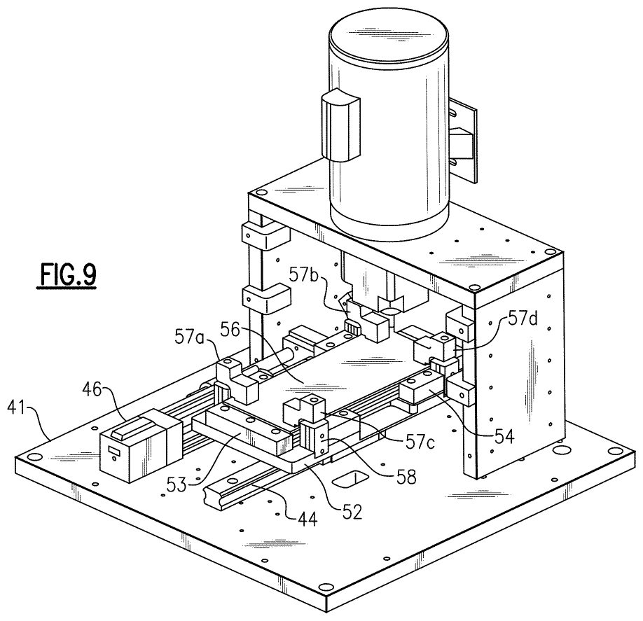

FIG. 8 shows a detailed assembly of the mechanism assembly 121. All of the components of the mechanism assembly 121 are built on the mechanism base 41 as shown in FIG. 8. From bottom to top, the components are introduced as follow. A vacuum set is assembled on the mechanism base 41 including two vacuum device supports 42 and a vacuum device 43. On top of the vacuum set, there is a linear bearing 44 with a linear bearing couple 45. A linear motor 46 is connected to the linear bearing couple 45 for providing a driving force for the tray notch machine 100. When cooperating with the linear motor 46, the linear bearing 44 serves a function of constraining relative motions of the linear motor 46 to only the desired motion, and reduces friction force. The linear motor 46 is attached with a linear motor front couple 47 and a linear motor side couple 48 as shown in FIG. 8.

A front cover 49 and a back cover 50 are inserted at the front and back of mechanism assembly 121, supported by the mechanism base 41. The front cover 49 as shown in FIG. 8 may be shaped to fit the outer shape of the set up underneath. The material of the front cover 49 and back cover 50 may be glass or other high transparency material which allows operators to observe the interior view through the covers. Four front cover supports 51 are also placed at the edges of the front cover 49 and fixed at two motor side supports 62 which will be introduced in detail.

A tray base 52 is assembled on top of the linear bearing 44 and is connected with the linear motor 46. On top surface of the tray base 52, a set of base guides which may be metal blocks are set up including a front guide 53, four side guides 54 which are placed by two side guides on each length of the tray base 52, and a back guide 55. A set of trays 56 to be processed can be placed and secured on the tray base 56 by aligning with the base guides 52, 53 and 54 at each side. Four tray clamps 57 and four corresponding tray clamp cylinders 58 are engaged at the four corners of the set of trays 56, in order to fix the trays at the desired position on the base 56.

A drilling assembly is illustrated above the set of trays 56. The drilling assembly includes an end mill or bit 59 for drilling and cutting and a collet 60 which forms a collar around the end mill 59 for holding it in position and exerting a strong clamping force on when it is tightened. The drilling assembly also includes a tool holder 63 and a tool holder nut 61 for securing the tool holder 63 on the tool holder base 67. In side of the tool holder base 67, two bearings 64 are stacked on the top end of the tool holder 63 and connected with a motor couple 66 by placing a bearing spacer 65 in between. The described drilling assembly is surrounded by two motor side supports 62 at each side and a motor support 68 at the top. The two motor side supports 62 are supported by the mechanism base 41. The above described front cover 49 and back cover 50 may be further described as inserted shields at the front and back with respect to the drilling assembly. The motor support 68 at the top of the drilling assembly may be processed to include a hole at the center which is configured to allow the motor support 68 to extend out of the motor support 68 and connect to a motor 69. The motor support 68 may also be shaped to match the shape of the motor 69 and allows the motor 69 to sit and secure on the motor support 68. At the drilling assembly, close to the end mill 59 of the drilling assembly, an air manifold 70 is attached with three air nozzles 71 in order to clean up the debris that may be generated during the drilling process.

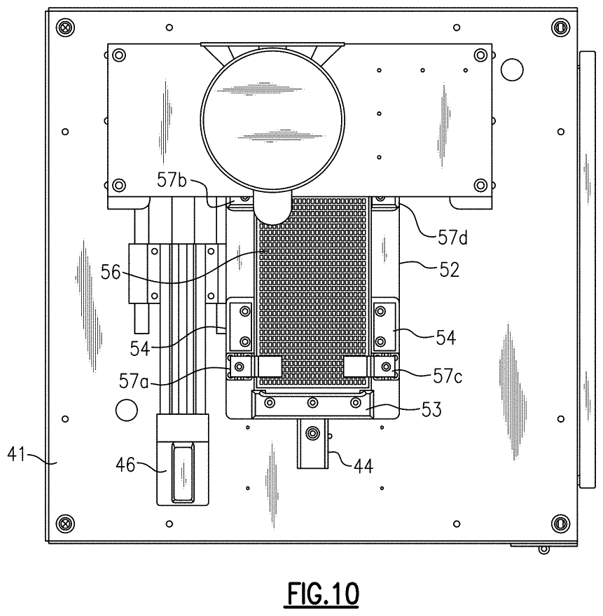

FIGS. 9 to 11 demonstrate the isometric views from different directions and the top views to show the inside configuration of the mechanism assembly 121 that carries out the core operation of the automatic tray notch machine 100. During the operation, the plurality of trays 56 to be modified may be loaded on the tray base 52. The position of the plurality of trays 56 may be controlled accurately by aligning with the front guide 53, the four side guides 54 at each side of the tray base 52, and the back guide 55. The plurality of trays 56 may be fixed in position by the four tray clamps 57. The four tray clamps 57 may include tray clamps 57a and 57b at one side of the tray base 52 and tray clamps 57c and 57d at the opposite side of the tray base 52. The four tray clamps 57a to 57d are operated by a pneumatic system operated by different pneumatic valves. The mechanism and the corresponding pneumatic diagram are shown in FIG. 13. Each tray clamp 57 is supported by a corresponding tray clamp cylinder 58 which is equipped with a number of sensors for detecting the position of the loaded trays and communicating with the pneumatic tray clamps 57, in order to press or release the plurality of trays 56.

In some embodiments, the tray base 52 accepts a maximum of four trays per load in a single stack. Once the plurality of trays 56 are loaded and secured on the tray base 52, the linear motor 46 is activated when an instruction is given by the operator, for example by pressing the start button 25. The linear motor 46 can control the movement of the plurality of trays 56 on the tray base 52 in a forward or a backward direction with respect to the drilling tool near the back side of the tray notch machine 100. The front cover 49 of the mechanism assembly 121 which is transparent and therefore, not shown in FIGS. 9 to 11 is shaped to leave space for the tray clamps 57 and tray to move freely through the front cover 49. The front cover 49 protect the drilling process and shield debris that may be generated during the drilling process.

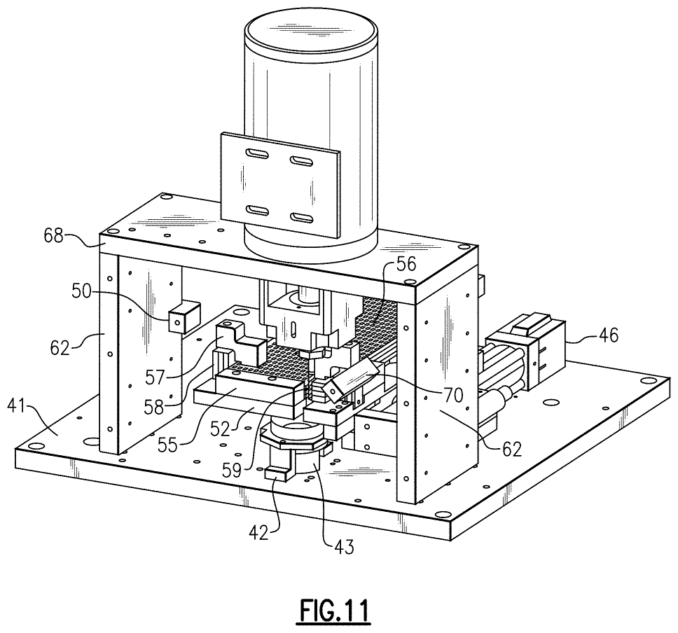

The drilling tool is located at the back side of the tray notch machine 100—behind the front cover 49. A clear illustration can be seen in FIG. 11. The drilling tool includes an end mill 59 which serves to cut the plurality of trays 56 with a notch for each of the tray at the same position and at the same time. The air manifold 70 with three air nozzles 71 (see FIG. 8) is equipped at one side of the drilling tool and is driven by a pneumatic system which is shown and described in FIG. 13. The air manifold 70 may supply high pressure air through the three air nozzles 71 in order to blow away the debris generated by the drilling tool. The vacuum device 43 at the bottom of the mechanism assembly 121 may then suck the debris and collect them into the waste container in the bottom frame assembly 122.

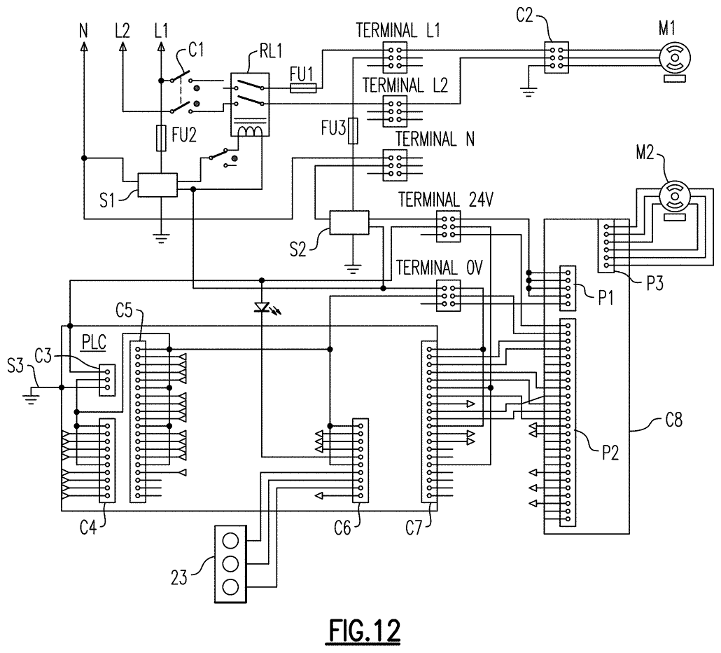

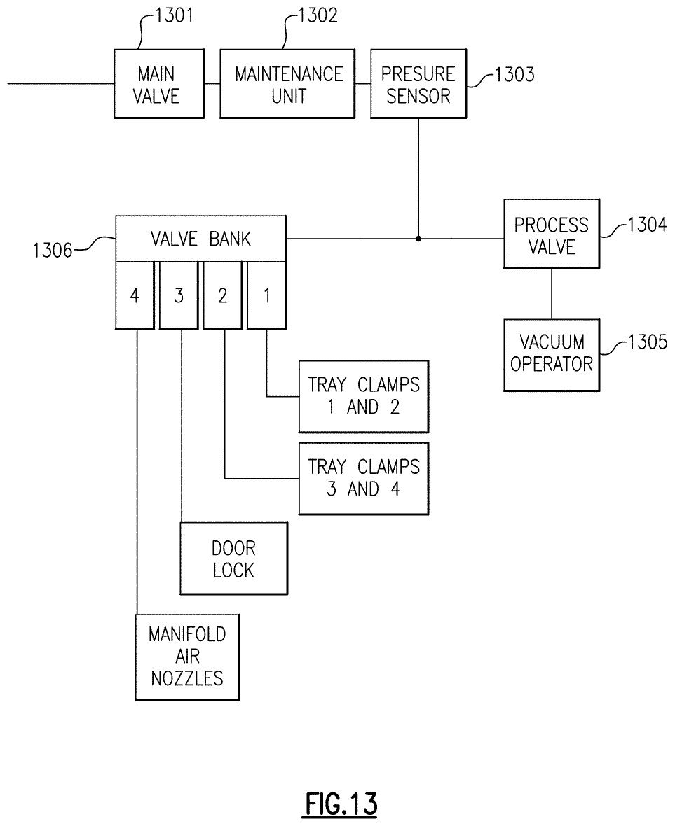

FIG. 12 shows an assembly of the electrical system for the automatic notch machine. The electrical system of the notch machine may be divided into three main parts, including a set of control circuits connected to a motor M1 as shown at the top of FIG. 12, a set of assembly within a programmable logic controller (PLC) as shown at the bottom left of FIG. 12, and a controller connected to a linear motor M2. The set of control circuits at the top of FIG. 12 includes two power supplies which are a 24V direct current (DC) power supply S1 and a 24V DC power supply S1 for providing power sources to the control circuit. As shown in FIG. 12, the 24V DC power supply S1 is configured to connect to a first port of a Terminal L1 and a first port of a Terminal L2. At the same time, the other ports of the power supply S1 are connected to a first port of a 0V Terminal, a neutral line and a ground line respectively. The DC power supply S2 is configured to connect to a second port of the Terminal L1. The other ports of the DC power supply S2 are connected to the first port of the 0V Terminal, a second port of a Neutral Terminal and a first port of a 24V Terminal. The whole control circuit is protected by a set of protective components including a circuit breaker C1 with two switches between the DC power supply S1 and the Terminal L1 and Terminal L2. The circuit breaker C1 is an automatically operated electrical switch designed to protect the control circuit from damage caused by excess current from an overload or short circuit. The breaker circuit C1 may be operated to interrupt current flow if a fault is detected. The circuit breaker C1 is then connected to a relay RL1. In some embodiments, a PCI-224DMH power relay may be used. The protective components may also include a plurality of fuses to provide overcurrent protection, including a fuse FU1 between the circuit breaker C1 and the Terminal L1, a fuse FU2 between the DC power supply S1 and the circuit breaker C1, and a fuse FU3 between the DC power supply S2 and the Terminal L1. The relay RL1 extends two terminals controlled by two switches separately towards the first port of the Terminal L1 and the first port of the Terminal L2. At the other side of the Terminal L1 and Terminal L2, they are configured to connect to a motor M1 through a variable frequency drive C2. The motor M1 may be the motor 69 of the drilling assembly for driving the drilling tools.

The electrical assembly of the PLC is shown at the left bottom of FIG. 12. A PLC is an industrial computer control system which may continuously monitor the state of input devices and make decisions based upon a custom program to control the state of output devices. The electrical assembly of the PLC begins at a power supply terminal C3. Two ports of the power supply terminal C3 connects both a second port of the 24V Terminal and an alternative current (AC) power supply S3. A third port of the power supply terminal C3 is configured to connect to two controllers C4 and C5 through a plurality of connection ports. The two controllers C4 and C5 serve the inputs of the PLC system and include a plurality of controls. The operations of PLC include the red stop button 24, the green start button 25, and the black reset button 26 at C4. The PLC also controls the operations of the four tray clamps 57 separately at C4, labeling them with left up clamp, left down clamp, right up clamp, and right down clamp. The PLC controls the door in front of the notch machine including the left door, right door and back door, as well as the interlock of the door which may be activated or withdrawn at C5. The PLC further controls the pressure sensor, PM screen, and guard spindle.

The PLC electrical system also includes a PLC relay C6, in order to prevent the accumulation of cables from the power supply on the components in the PLC circuits. The safety relay C6 may be used which is responsible for security issue and may shut down the when a problem occurs and is detected by the machine operator. Therefore, the interlock of the front door of the tray notch machine 100 is linked to this safety relay C6. At C6, three terminals are directly connected to the status traffic light 23 which serves the three colors for signaling different messages to the machine operator. The PLC electrical system further includes another controller C7 which is powered by the 24V Terminal and the 0V Terminal. In some embodiments, a controller C0-16TD1 may be used. The controller C7 may be configured to operate the air manifold of the notch machine, and provide variable frequencies as an output.

The controller C7 is then connected to another controller C8 outside the PLC electrical system which is shown at the right bottom of FIG. 12. In some embodiments, the controller C8 may be a LECP6 controller. The controller C8 may be divided into three parts including P1, P2 and P3. At P1 of the controller C8, a plurality of power supply terminals are provided from the 24V Terminal and the 0V Terminal. At P2 of the controller C8, the controller C8 is connected to the controller C7 within the PLC electrical system through a plurality of connection ports. At P3 of the controller C8, it may include a SMC motor driver which is configured to connect to a linear motor M2. The linear motor M2 may be the linear motor 46 of the notch machine for driving the movements of the tray base.

FIG. 13 shows a pneumatic diagram demonstrating the assembly and mechanism of the pneumatic equipment for operating the automatic tray notch machine 100 according to the present disclosure. The purpose for using a pneumatic operation for this automatic tray notch machine 100 may be to utilize the high-pressure air through channels within the operation and to drive the aimed actuators of different parts of the notch machine. The pneumatic operation is mainly based on the reduction in the volume of the air by utilizing an air compressor which gives rise to an increase in the pressure of the air. This then moves through a filter into pneumatic tubing where it is controlled by a plurality of valves before reaching the aimed actuators. The assembly starts with a main valve 1301 which will control the air supply to the equipment. The main valve 1301 is connected to a maintenance unit 1302 which is connected to a pressure sensor 1303 for monitoring and controlling the pneumatic pressure within the assembly. From the pressure sensor 1303, the flow of air may be divided into two branches. The first branch provides the flow of air into a vacuum operator 1305 through a process valve 1304. The second branch provides the flow of air into a valve bank 1306 which is then further divided by four different channels, namely channels 1, 2, 3 and 4. The air flow in channel 1 is used to drive two tray clamps out of the four tray clamps (named as tray clamps 1 and 2 as shown in FIG. 13). The air flow in channel 2 is used to drive the other two tray clamps (named as tray clamps 3 and 4 as shown in FIG. 13). The air flow in channel 3 is used to drive the door interlock and in channel 4 is used to drive the manifold air nozzles.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed systems and methods.

1. An automatic drilling equipment for drilling notches in a plurality of trays, the equipment comprising:
a drilling tool; and
a tray base configured to hold and move a plurality of trays on the tray base with respect to the drilling tool, said drilling tool configured to drill the plurality of trays to open a notch at the same position in each tray of the plurality of trays at the same time.

2. The automatic drilling equipment of claim 1 wherein the plurality of trays are packaging trays for failure chips.

3. The automatic drilling equipment of claim 1 wherein the plurality of trays consists of four or more trays in a stack.

4. The automatic drilling equipment of claim 1 wherein the tray base further includes at least one tray clamp for securing the plurality of trays on the tray base.

5. The automatic drilling equipment of claim 1 wherein the drilling tool includes a motor for driving a drilling process.

6. The automatic drilling equipment of claim 1 further comprising a vacuum cleaning tool for cleaning debris generated by the drilling tool during a drilling process of the plurality of trays.

7. The automatic drilling equipment of claim 4 wherein the at least one tray clamp is a plurality of tray clamps that include a plurality of sensors configured to detect the presence of a loaded plurality of trays on the tray base.

8. The automatic drilling equipment of claim 1 wherein the tray base further includes a bearing tool for controlling the movement of the tray base.

9. The automatic drilling equipment of claim 1 further including a pneumatic system for operating a drill tool.

10. The automatic drilling equipment of claim 1 further comprising a maintenance screen.

11. The automatic drilling equipment of claim 1 further comprising a status traffic light.

12. The automatic drilling equipment of claim 1 further comprising an emergency stop button.

13. The automatic drilling equipment of claim 1 further comprising access doors for shielding the drilling tool.

14. The automatic drilling equipment of claim 1 further comprising a reset button, a start button and a stop button.

15. The automatic drilling equipment of claim 6 further comprising a cabinet, an upper compartment of the cabinet containing the drilling tool and a lower compartment of the cabinet containing the vacuum cleaning tool.

16. An automatic drilling method for trays, comprising:
loading a plurality of trays on a tray base;
moving the plurality of trays with respect to a drilling tool by a motor connected to the tray base; and
drilling the plurality of trays with the drilling tool to simultaneously open a notch at the same position for each tray of the plurality of trays.

17. The automatic drilling method for trays of claim 16 wherein the plurality of trays are packaging trays for failure chips.

18. The automatic drilling method for trays of claim 16 wherein the plurality of trays consists of four or more trays in a stack.

19. The automatic drilling method for trays of claim 16 further comprising securing the plurality of trays on the tray base with one or more tray clamps.

20. The automatic drilling method for trays of claim 16 further comprising driving the drilling tool via a motor.

21. The automatic drilling method for trays of claim 16 further comprising cleaning debris generated during the drilling step with a vacuum cleaning tool.

22. The automatic drilling method for trays of claim 19 further comprising detecting the loaded plurality of trays on the tray base with one or more sensors.

23. The automatic drilling method for trays of claim 16 further comprising controlling the movement of the tray base via a bearing.

24. The automatic drilling method for trays of claim 16 wherein the drilling step is operated by a pneumatic system.
